(19) United States
(12) Patent Application Publication
(10) Pub. No.: US 2020/0026834 A1
(43) Pub. Date: Jan. 23, 2020

(54) BLOCKCHAIN IDENTITY SAFE AND AUTHENTICATION SYSTEM

(71) Applicant: One Kosmos Inc., Jersey City, NJ (US)

(72) Inventors: Hemen R. Vimadalal, Jersey City, NJ (US); Rohan Pinto, Jersey City, NJ (US)

(21) Appl. No.: 16/042,764

(22) Filed: Jul. 23, 2018

(51) Int. Cl. G06F 21/32; G06F 17/30; H04L 9/32; H04L 9/08; H04L 9/06

(52) U.S. Cl. CPC G06F 21/32; G06F 17/30194; G06F 17/30185; H04L 2209/38; H04L 9/0825; H04L 9/0643; H04L 9/3231

(57) ABSTRACT

The present invention relates to a system and corresponding method for creating an identity safe in which a user's identity and other data (such as payment data) is securely stored. An identity safe service provider receives from the user's device (e.g., smartphone) at least two forms of the user's identity (e.g., driver's license and passport). The identity safe and third party service providers verify the user's identity data. The identity safe service provider generates a public key and a private key associated with the user, the private key being sent to and retained by the user's secure smartphone keychain. The identity safe service provider encrypts and signs the verified user identity data with the private/public key pair, and adds that data to a blockchain ledger as a new entry. The new entry is cryptographically linked to a prior entry on the blockchain ledger to form the identity safe, which is immutable and incorruptible. An online service provider may subsequently verify the signature and decrypt the user's identity data with the user's private/public key pair to authenticate the user.

### BACKGROUND OF THE INVENTION

### Field of the Invention

This invention relates to an identity authentication system whereby a user's identity data is encrypted and signed with the user's private/public key pair, and stored securely on a blockchain ledger using decentralized and verifiable identifiers.

### Background of the Invention

The two greatest obstacles with web services today are verifying a user's identity and securing the user's data. For example, web services rely on relatively insecure usernames and passwords. Two-factor authentication can provide an extra layer of security, by additionally requiring something only users have on them, that is, a piece of information only they should know or immediately have on hand such as a physical token. However, two-factor authentication typically never validates the user on the other end of the verification. Traditional siloed identity management (IDM) systems rely on Web service based authentication which is inefficient and insecure. This is primarily because data is stored in a central database making it a target for hackers to attack and compromise a single database and get access to all the information in the IDM system. Web service protection is also inconsistent, ranging from strong to barely existent. Further, authentication data quality may vary wildly; on the low side, the data may include inaccurate, incomplete and outdated identity information.

These shortcomings are problematic for today's $4 trillion digital economy, where money is sent across the world in milliseconds and everything from buying food to submitting a job application has moved online. Yet simply proving who you are to those who genuinely need to know has remained stubbornly rooted in the legacy age of paper. Try opening a bank account, applying for a government service or even buying a SIM card for a mobile device, and you'll need to provide a physical identity such as a driver's license that is then digitally scanned or photocopied to satisfy regulatory requirements. Maintaining valid identity information across these multiple online stores can be challenging for individuals and companies alike. A bank, for example, may spend $60 million annually on Know Your Customer (KYC) compliance. Even digital identity information has resisted innovation, leading to a mishmash of imperfect solutions.

There are still other significant problems associated with both physical and digital identities used, for example, for authentication purposes. First, there is a proliferation of physical and digital identities associated with an individual, starting right after birth and continuing throughout his or her life. For example, a 5-year-old child may have a few identities, such as a birth certificate, a social security number and a passport. A teenager may additionally have a diploma, a driver's license, a health insurance card, a debit or credit card, a library card, and numerous social media accounts (e.g., Instagram®, Facebook®, Twitter®) and their associated user identities and passwords. By mid-life, an adult may have many scores of digital identities, in addition to all the physical identities they carry, which are typically centrally managed by companies and government organizations in their own siloed IDM systems. Those systems, however, are honey pots for hackers who desire to maliciously attack the digital identities, steal them, or otherwise compromise their integrity.

Worse still, users have little or no control over their own digital identity information when subscribing to a company's online service, especially when it's free to use. The users' identities are typically managed and often monetized by the company. The users usually have no control of what level of information they would like to share with the company; instead, there is only a minimal amount of privacy to which the users consent. Users often have to share more personal information than they would otherwise need to share to complete a transaction. This not only reduces their privacy, but also leaves them exposed to hackers.

The users' identities are also vulnerable to a slow, insecure, cumbersome and repeated verification process. For example, users submit applications to open online bank accounts and provide their identities for verification—so the bank can make sure the users are in fact who they contend to be. Hardcopies of their physical identity documents (e.g., driver's licenses, passports or utility bills) and perhaps also their digital identities (e.g., social security numbers) are mailed, emailed or otherwise transmitted to the bank. The bank replicates all that information, which it then sends to one or more verification providers. Each verification provider gets copies of the documents and other identification information, and creates more copies (or extracts the users' identity data therefrom) to send to one or more third party sources for verification. The third party sources send the verification results back to each verification provider for compilation and processing. Compiled and processed verification results from all the verification providers are then sent back to the bank, which in turn provides the final verification result back to the users. This cumbersome and repetitive verification process typically takes between 5 and 50 days to complete, which is likely to be perceived as painfully slow relative to the nearly instantaneous computer feedback that is nowadays commonplace. And despite the efforts of the banks, the verification providers, and the third party sources to keep secure all of the identity information being sent around, the verification process is nonetheless susceptible to both hacking and identity theft.

These and other identity authentication problems exist on the enterprise side too. For example, significant time, money and resources are wasted when employees' badges are lost or customers' passwords are forgotten (which is becoming more an issue nowadays with relatively long passwords comprised, for example, of 12 mixed alpha-numeric characters and symbols). It would be desirable for companies, governments and other enterprises to reduce the cost and size of their IDM systems, help desks, and anti-fraud/risk reduction systems.

### SUMMARY OF THE INVENTION

As will be described in detail below, the present invention improves upon existing identity authentication systems and their problems. In one embodiment of the present invention, a user's identity data, which has been verified based on NIST 800-63 standards, encrypted and signed by the user's private/public key pair, and stored in an identity safe located on a permissioned/permission-less ledger of an immutable blockchain that uses robust cryptography for storage and access. The identity safe is replicated across multiple computing nodes on the blockchain and is thus decentralized, thereby reducing the need for each service provider to store the users' credentials and be the single point of failure. The identity safe provides self-sovereign identity by permitting the credential's owner (the user) to control privacy—what identity information will be shared when and with whom.

### BRIEF DESCRIPTION OF THE DRAWINGS

FIG. 1 depicts an exemplary operational flow of an identity safe app in accordance with the present invention.

FIG. 2A depicts an exemplary operational flow of a secure login to an online banking service, and FIG. 2B depicts an exemplary operation flow for pairing a user's workstation computer to the user's smartphone via an agent, in accordance with the present invention.

FIG. 3 depicts an exemplary operational flow of a secure payment to an online shopping service in accordance with the present invention.

FIG. 4A depicts a hierarchical architecture of an example of the present invention, including components thereof.

FIG. 4B depicts examples of blockchain ledgers in accordance with the present invention.

FIG. 5 depicts the operational flow of an exemplary registration process in accordance with the present invention.

FIG. 6 depicts the operational flow of an exemplary authentication process in accordance with the present invention.

FIG. 7 depicts the operational flow of an exemplary recovery process in accordance with the present invention.

FIGS. 8 and 9 respectively depict the components and operational flow of an exemplary Windows workstation authentication process in accordance with the present invention.

FIG. 10 depicts the operational flow for a disassociating a user from the identity safe app of the present invention.

### DETAILED DESCRIPTION OF THE INVENTION

Specific embodiments of the invention will now be demonstrated by reference to the following examples. It should be understood that these examples are disclosed solely by way of illustrating the invention and should not be taken in any way to limit the scope of the present invention.

The present invention takes advantage of blockchain technology to provide an efficient identity authentication system and process that is constantly updated, accessible to anyone, verified by a distributed computer network, and highly secure. This invention also enables users and companies (and others) to move away from paper-based physical identity and into digital identity, and provides enhanced privacy, security, transparency and individual rights.

In one aspect of the present invention, and as will be discussed in more detail below, a user signs into a smartphone identity safe app to store his or her verified physical and digital identity data, that has been encrypted and signed by the user's own private and public keys that only the user has access and control over. The user maintains control over his or her unique private key which is part of the secure keychain storage of the user's smartphone. The data captured in the identity safe is stored by the identity safe service provider on a blockchain: the signed, encrypted identity data and public key are added to the ledger as a new entry, which is then cryptographically linked to previous ledger entries to form an immutable blockchain. The identity safe service provider allows the data to be stored in either a permissioned or permission-less blockchain.

In another aspect of the present invention, the identity safe service provider can quickly and readily provide the user's verified identity data captured in the identity safe to third parties (companies, governments, hospitals, insurers, airlines and other enterprises), which need that data to verify the user's identity, and if applicable, undertake a transaction with the user. The type and amount of identity information to be shared with third parties is under the user's control, so the user can ensure that only the minimal identity data required for verifying the user's identity and completing the transaction is shared with the third party, control, so the user can ensure that only the identity data required for verifying the user's identity and completing the transaction is shared with the third party, and nothing more. For example, if the user only needs to provide his or her name and address, then only that information is provided to the third party, and not the user's Date of Birth, Driver License number, etc.

Rather than a standard username and password, the present invention uses biometric information (e.g., a user's fingerprint, voiceprint or facial image entered into the smartphone app) to authenticate a user who wants to access, or to permit access, to his or her identity safe. For example, after a user has been authenticated by the entered biometric information, his or her encrypted, verified identity data is retrieved from the blockchain's ledger. The user's private/public key pair is then used to verify the signature and decrypt the user's verified identity data, which is then sent to the data's requester (the user or third party).

As mentioned above, the present invention uses blockchain technology to provide a secure identity safe. A blockchain is a ledger of identical blocks of data distributed on a network of peer-to-peer computing nodes, which virtually eliminates single point failure and prevents control by a single entity. This ledger maintains a continuously growing list of ordered records that are securely linked together using cryptography. When information needs to be added or updated to the ledger, the change is verified, authorized, timestamped, recorded and sealed in a “block” of data, unable to be edited again. The new data block is added to the blockchain by linking it via a cryptographic hash to the previous data block.

The updated blockchain is quickly published to, and stored by, all the computing nodes (e.g., online servers) of the blockchain network. The database may thus serve as a complete, chronological record of all digital transactions—a secure public ledger identically maintained by each computing node in the network. Because of data distribution and encryption, digital transactions entered on this ledger are immutable, that is, incapable of being retroactively changed. Moreover, private key encryption eliminates the need for a trusted third party or intermediary to prove the user's identity authentication/ownership (i.e., you are who you say you are), and the blockchain's protocol authorizes permissions (i.e., you may do what you are trying to do). Blockchain thus facilitates secure, authenticated and authorized digital transactions without the need of a trusted central authority.

Consequently, the identity safe (and its contents) of the present invention is replicated across the multiple computing nodes of the blockchain network, so there is no centralized database and no single point of failure. The blockchain acts as an index of identifiers and an audit trail for the exchange of verifiable claims. The security and anonymity inherent to blockchain protects the user's identity data in the identity safe in ways that no legacy identity management system can match.

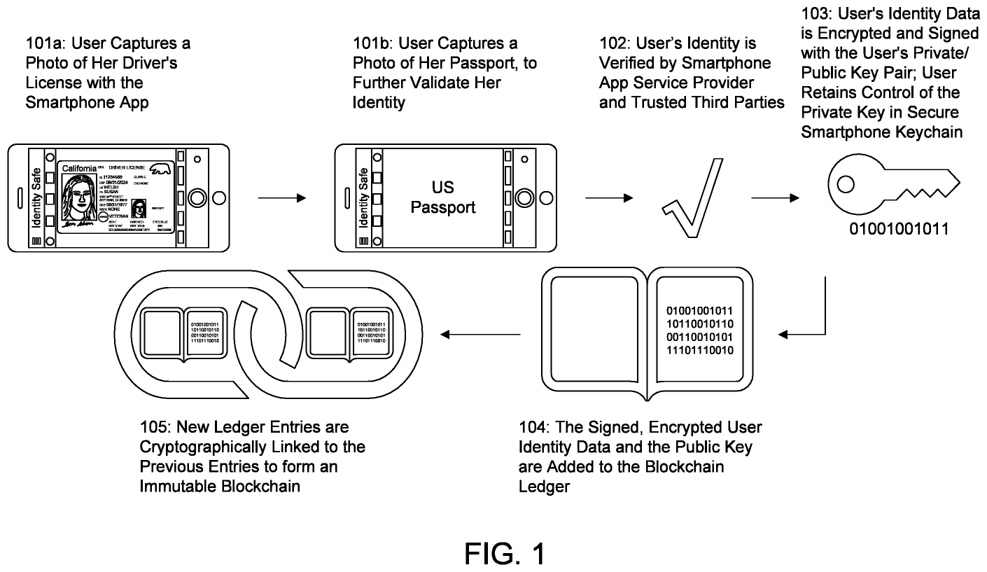

One example of the present invention is shown by FIG. 1, and comprises an identity safe smartphone app (which is used with one or more other smartphone apps and devices, like a camera or voiceprint or fingerprint capture devices) to access an identity safe provided by an identity safe service provider. The identity safe smartphone app is communicatively connected to (for example, by the Internet) and interacts with the corresponding software on the identity safe service provider's computer. A user signs into the identity safe application using biometric information as described above, and once the user has been authenticated by the identity safe service provider, may store or retrieve identity information into and out of the identity safe.

In order to create an identity safe, there are a few steps required to capture, verify and proof a user's identity. The standards used to verify and proof the user are based on NIST 800-63-3 https://pages.nist.gov/800-63-3/sp800-63-3.html. When a user registers the identity safe app, the user is put in the first level of assurance (LOA). However to move to the next level, a user is required to scan two forms of trusted identity information in the identity safe. These two can be a passport and a driver license, for example. The user digitally images his or her driver's license and passport—a physical identity—using the smartphone's camera, as shown in step 101 (101a and 101b) of FIG. 1. These two trusted sources are used to validate the user's identity. Other government-issued identification cards, insurance cards, credit and debit cards, letters of credit, educational, professional and other credentials can also be scanned and captured.

In step 102, the newly-entered identities, such as the driver's license and user passport captured in step 101, are verified by the identity safe service provider and trusted third parties to ensure that they are valid, have not been reported lost or stolen, and truly belong to the user. In step 103, the user's verified identity data is encrypted and signed with the user's private/public key pair. The user retains control of the private key in the secure smartphone keychain. Thus, the user's verified identity data is tied to the user's private key, which provides secure access to the user's identity safe and allows only the user to decrypt his or her verified identity data. In particular, because only the holder of the private key can decrypt that data, that person must be the credential's owner, i.e., the user. Consequently, neither the identity safe service provider nor third parties can decrypt the user's verified identity data, making it secure.

In step 104, the user's signed, encrypted identity data and public key is securely stored, by the identity safe service provider, in the user's identity safe as a new ledger entry on a blockchain ledger. In step 105, the new ledger entry is cryptographically linked to previous ledger entries to form an immutable blockchain. This means that the user's identity safe and its contents are resistant to forgery or tampering. The entire process of entering a few physical and digital identities and storing them in the identity safe typically only takes a few minutes to complete. When done, a Level of Assurance of 3 or higher is achieved.

The identity safe of the present invention thus solves the problems discussed above. The paper-based physical identities (for example, driver's license and passport) are digitally imaged and converted into digital identities. The identity safe service provider can store those and the scores of other physical and digital identities a user might have both accurately and up-to-date, in a single identity safe, which is accessible only through a private key securely retained by the user.

Because the user's identity data is not stored on the user's smartphone, but on a blockchain's ledger, if the smartphone breaks or is lost or discarded, the identity data is still available, having been securely stored in the user's identity safe. As will be described below, the user merely needs to perform a recovery process for a new smartphone.

Copies of the blockchain's ledger, and thus the user identity safe, are maintained on the nodes of a decentralized computer network. Thus, the user's identities are not susceptible to a single point of failure. Also, the user's identities no longer need to be stored in inefficient and insecure siloed IDM systems, each centrally managed by a different entity. Instead, the blockchain and thus the user identity safe are immutable, virtually incorruptible, and secure from hackers.

Moreover, users retain control over their identity data in the identity safe, and may choose what information to reveal and to whom. Users can thus reduce the amount of identity data they expose to third parties, increasing their privacy and inhibiting hacking.

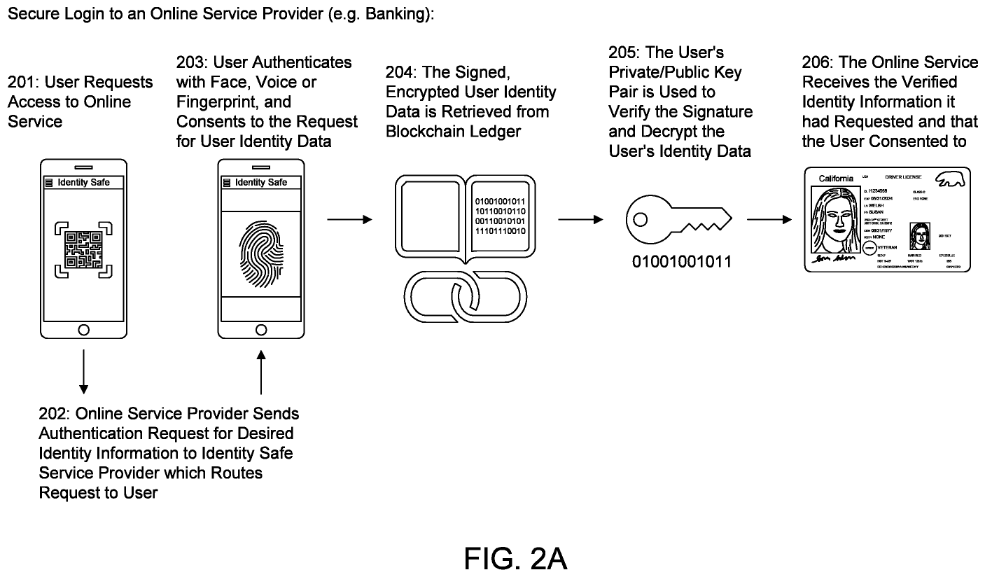

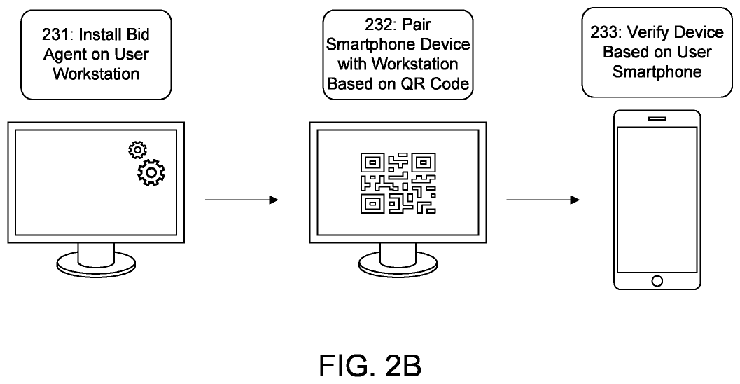

Once the user's identity information has been captured and verified by the identity safe service provider, the identity safe of the present invention can be used for authentication and proofing use cases across multiple third party service providers. For example, the identity safe of FIG. 2A is used by an online banking service app to obtain a secure login. This online banking service app is communicatively connected to (e.g., via the Internet) and interacts with the corresponding software on the online banking service provider's computer and on the identity safe software provider's computer.

In step 201, the user makes a login request to the online banking service app. The identity data as part of the login request includes scope information, i.e., personal information about the user, such as the user's first or last name, date of birth or address. There is also provided an agent that runs on user's computer (such as a workstation). As shown in FIG. 2B, steps 231-233, the agent pairs the user's computer to the user's smartphone and routes all authorization requests to the user's smartphone. In step 202 of FIG. 2A, an authentication request for the user's identity information (for example, the user's driver's license) is issued by the online banking service provider to the identity safe software provider, which in turn is routed to the user's smartphone. The identity safe service provider decodes the data coming from the agent, determines the user from the scope information, and then requests that the user enter his or her biometric data (e.g., facial image, voiceprint or fingerprint).

In step 203, the user enters his or her biometric data on his or her smartphone and consents to the online banking service provider's request for the specified user identity data. After the identity safe service provider has authenticated the user by the entered biometric data, in step 204, the signed, encrypted identity data is retrieved from the blockchain's ledger. In step 205, the user's private key/public key pair is used to verify the signature and decrypt the user's identity data. In step 206, the online banking service provider receives the user's driver's license it had requested and the user had consented to provide.

With the present invention, verification is done once for a service provider and securely; no paper or electronic copies of documents have to be made or passed around; and no identity information needs to be manually extracted from such documents. The user's verified identity information can be quickly retrieved from the identity safe and provided to online banks, businesses, and e-governments for secure authentication, payment and other purposes. This solves the previously discussed problem of slow, cumbersome, repetitive and insecure verification processing.

Unlike a username and password which can be hacked, the user's smartphone must work and the biometric information must match to gain access to the identity safe, so the user's identity data is safely protected. Furthermore, only the requested and consented to identity data need be revealed to the third party service provider; in the example of FIG. 2, only the driver's license is consented to by the user and provided to the online banking service provider, but none of the other identity information in the user's identity safe.

The blockchain thus serves as a decentralized source of authentication; in essence it acts as a single-sign-on portal that can be accessed by any service provider while not being owned by any single entity. The online service only has to request a digital signature from the user and the corresponding identity data in the identity safe on the blockchain ledger. The user's signature is then verified as being valid—that is, it matches the one used to sign the identity data in the blockchain. This verifies that the user is who he or she contends to be, and that the verified identity data truly belongs to the user.

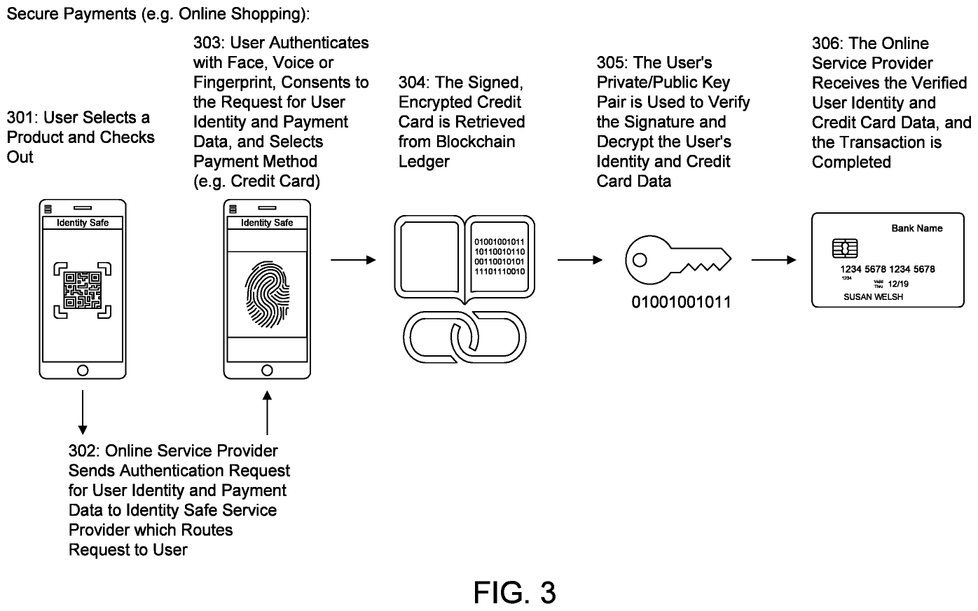

The present invention may also be used to make payments to online services or businesses. The verified identity information in the user's identity safe, such as credit and debit cards and even crypto currency, permits faster, easier and more secure payments. Moreover, the user can ensure that only the information necessary for the transaction is revealed to the online service or business. For example, as shown by FIG. 3, a secure payment is made to an online shopping service.

In step 301, the user selects one or more products to purchase and desires to check out of the online shopping service app on his or her smartphone. The online shopping service app is communicatively connected to (e.g., via the Internet) and interacts with the corresponding software on the online shopping service provider's computer and on the identity safe software provider's computer. The checkout request contains scope information, i.e., personal information about the user, such as the user's first or last name, date of birth or address. As discussed previously and as shown in FIG. 2B, an agent running on the user's computer pairs that computer to the user's smartphone and routes all authorization requests thereto. The online shopping service provider sends the scope and other information, and in step 302 makes an authorization request for the user identity and payment data it needs for authenticating the user and completing the purchase to the identity safe software provider, which in turn is routed to the user's smartphone. The identity safe service provider decodes the data coming from the agent, determines the user from the scope information, and requests that the user enter his or her biometric data (e.g., facial image, voiceprint or fingerprint).

In step 303, the user enters his or her biometric data on the smartphone, consents to the online shopping service's request for the specified identity data—in this example, payment information—and selects a method of payment (e.g., by selecting a credit card in the identity safe). After the identity safe service provider has authenticated the user by the entered biometric data, in step 304, the signed, encrypted credit card data is retrieved from the blockchain's ledger. In step 305, the user's private/public key pair is used to verify the signature and decrypt the user identity and credit card data. In step 306, the online shopping service provider receives the user's identity and credit card data it had requested and the user had consented to provide, and completes the purchase.

Besides online banking and shopping services, the identity data stored in the identity safe can be used for other online services, for e-government services (like secure voting or polling, and declaring and paying taxes, certifying credentials), for securely logging into social applications, for verifying phone numbers, for securely connecting to and controlling Internet of Things (IoT) devices via IoT identities, just to name a few examples.

The present invention thus provides numerous benefits to consumers, online businesses, governments and other enterprises. Consumers benefit from privacy and enhanced security by design, as there are no usernames or passwords and no form filling. Web services benefit from secure authentication and verified users. Governments benefit from the ability to certify credentials (e.g., a driver's license). Financial services and online businesses benefit from secure transactions. Telephone companies benefit from being able to verify identity attributes (e.g., phone number). Identity brokers benefit from being able to provide Single Sign On (SSO) services. IoT device manufacturers benefit from being able to securely control connected devices.

Furthermore, the authentication of the present invention, secured by blockchain technology, provides the online service or business a high level of assurance that the user it is interacting with really is who the user claims to be. This is especially important for online businesses, where you may never meet a customer in person. The identity safe service provider solves this problem by providing Identity Assurance Level 3 (IAL3) and Authentication Assurance Level 3 (AAL 3) as defined by the US National Institute of Standards and Technology (NIST 800-63)—that is sufficient for financial institutions to achieve KYC compliance, and similar to a customer who shows up in person with just a driver's license. This level of assurance is also 100% compliant with the EU's General Data Protection Regulation (GDPR), the Pan-Canadian Trust Framework and Cyber-Authentication Technology Solutions Interface Architecture and Specification Version 2.0 (CATS2 IA&S).

Adding standard authentication protection, such as multi-factor authentication, typically requires systems that are costly and difficult to build, defend, and support. However, for online services and businesses, the enterprise-side authentication software is up and running in just a few hours. Moreover, this software uses its own machine learning-based cognitive AI for biometric protections and does not rely on the services of the underlying operating system, like the iPhone's fingerprint or face recognition software. Customer experience is also enhanced, as they need not worry about forgetting their usernames or passwords or about their accounts being compromised by stolen credentials, thereby giving them peace of mind. This is because biometric data such as face, voiceprint or fingerprint is used for user authentication, and the pertinent identity information in the customer's identity safe provides quick and secure access to online businesses, as well as the ability to make secure payments.

In yet another embodiment on the present invention, users may be paid to use their identity safes. In particular, when they use their identity safes to sign into an online service, the online service companies gives them identity tokens—a crypto currency like Bitcoin and Ethereum designed for identity transactions. This is because the online services and businesses are willing to pay the users for the simplicity and added security they get from the secure, authenticated and verified identity data, instead of, for example, a username and password which are vulnerable to hacking and fraud.

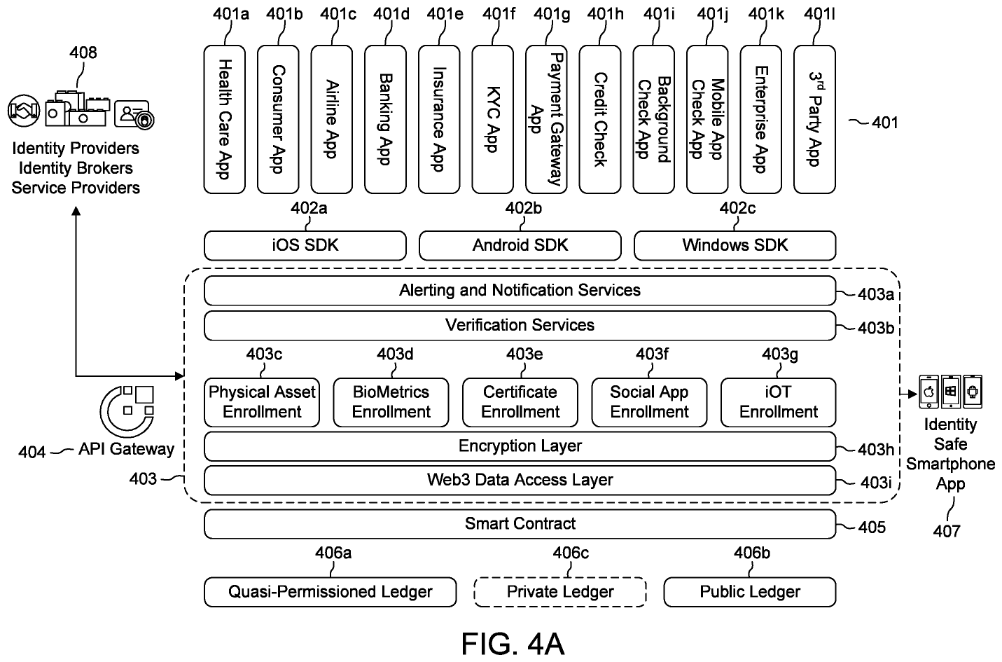

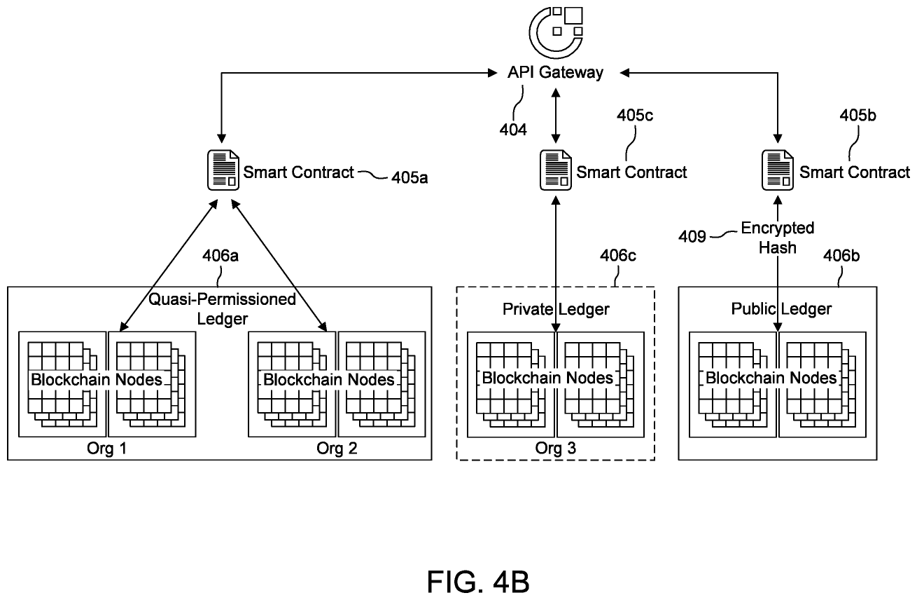

FIG. 4 depicts a hierarchical architecture of an example of the present invention and its components. An application layer 401 comprises one or more third party applications that may be used for authenticated login and payment purposes, such as described in connection with the examples of FIGS. 2 and 3, or for other purposes. These applications typically reside in part on the user's smartphone and in part on the service provider's computer, which are communicatively connected to each other, for example, via the Internet. These third party applications also are likewise communicatively connected to and interact with software modules 403 of the identity safe service provider. These applications may include but are not limited to Health Care App 401a, Consumer App 401b, Airline App 401c, Banking App 401d, Insurance App 401e, KYC App 401f, Payment Gateway App 401g, Credit Check App 401h, Background Check 401i, Mobile App Check App 401j, Enterprise App 401k, and 3^{rd} Party App 401l. Third party applications 401 may be developed, for example, using Software Development Kits (SDKs) for iOS 402a, Android 402b or Windows 402c.

The software modules 403 reside on the identity safe service provider computer and implement the identity safe. As described previously, this identity safe contains a user's identity information, for example, physical identities, digital identities, and IoT identities. The software modules 403 interact with (a) the third party apps 401 of the preceding paragraph; (b) the identity safe smartphone app 407 (an example of which is described above in connection with FIG. 1), which typically runs on an iOS, Android or Window operating system; (c) third party identity providers and brokers 408; and (d) the blockchain computer network, including smart contracts 405 and one or more ledgers 406a (Quasi-Permissioned Ledger), 406b (Public Ledger), and 406c (Private Ledger).

The software modules 403 include: alerting and notification services 403a; verification services 403b; enrollment modules to capture a user's identify information (e.g., physical asset enrollment 403c, biometrics enrollment 403d, certificate enrollment 403e, social app enrollment 403f, and IoT enrollment 403g); an encryption layer 403h; and a Web3 data access layer 403i. Verification of the users' identity data and LOA is performed by verification services 403b integrated with third party identity providers and brokers 408, such as Melissa, Postal Database and Passport Database. The encryption layer 403h preferably uses HMAC (hash-based message authentication code) cryptographic hash function applied over Advanced Encryption Standard (AES) 256 encryption/decryption for data storage, plus Elliptic Curve Digital Signature Algorithm (ECDSA) for data transfer. The Web3 data access layer 403i provides data access to a blockchain computer network, such as the Ethereum network. The API gateway 404 is the platform that interfaces with and handles the API service calls between software modules 403 and other computers.

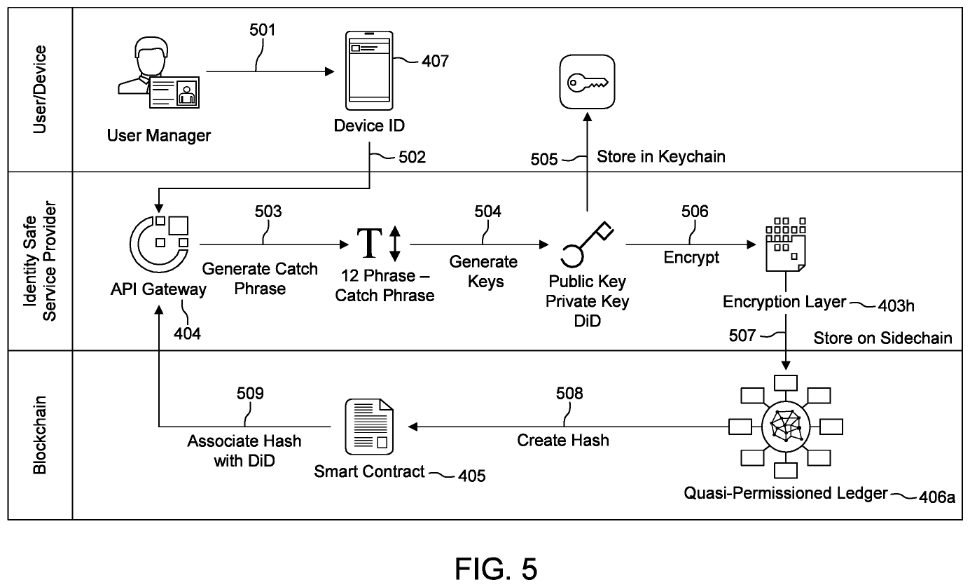

FIG. 4B depicts examples of blockchain ledgers in accordance with the present invention. As will be described in more detail with FIGS. 5-10, the software modules 403 of the identity safe service provider interact with API gateway 404 and smart contracts 405 to access the blockchain ledgers. Smart contracts 405a, 405b and 405c help to exchange identity and other information between the software modules 403 and respectively, a quasi-permissioned ledger 406a, a public ledger 406b, or optionally a private ledger 406c (shown in dashed lines), based on a distributed ID (“DiD”) which is compliant to W3C specifications and standards (https://w3id.org/did/vl). A smart contract 405b is used to record user transactions on the immutable public ledger 406b, for example, login attempt, form fill out, scope information, and identity information, as per the encrypted hash 409. A side chain comprising a quasi-permissioned ledger 406a (of organization 1 or organization 2) has dedicated nodes associated with the identity safe service provider, and is used to store user identity data as an encrypted hash value. This hash value can only be decrypted by the user private key located in user device. The software modules 403 may optionally interact with a private ledger 406c of organization 3 via a smart contract 405c if the organization decides to store their user identity data in a private blockchain.

FIG. 5 depicts the operational flow of an exemplary registration process in accordance with the present invention. In step 501, the user downloads the identity safe app 407 on his or her smartphone. In step 502, the smartphone's device id is passed through the API gateway 404 to the software modules 403 of the identity safe service provider, which, in step 503, generates a 12-word mnemonic catch phrase generated using the BIP 39 standard. That catch phrase is used, in step 504, to generate the ECDSA public and private keys. In step 505, the private key is stored in the keychain of the user's smartphone. In step 506, the DiD is encrypted using the user's ECDSA private key and signed with the public key by the encryption layer 403h, and in step 507, the encrypted hash blob of the DiD is stored on the side chain, i.e., on the quasi-permissioned ledger (e.g., Ethereum). In step 508, the quasi-permissioned ledger generates a hash, and in step 509, smart contract 405 will associate that hash to the DiD and send the DiD to the identity safe service provider via the API gateway 404, to be stored on the user's smartphone.

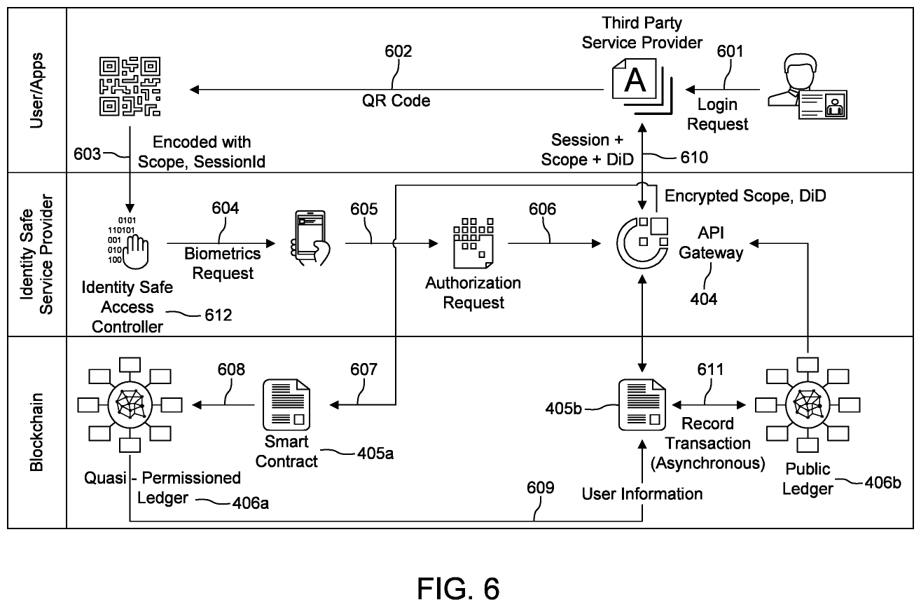

FIG. 6 depicts the operational flow of an exemplary authentication process in accordance with the present invention. In step 601, the user makes a login request on his or her smartphone to a third party service provider app. The identity data as part of the login request includes scope information, i.e., personal information about the user, such as the user's first or last name, date of birth or address. In step 602, the service provider creates and displays a QR code which is encoded with the scope information, the session id and the service provider's ECDSA public key, and requests the identity data it needs for authenticating the user. In step 603, the QR code is sent by the service provider to the access controller 612 of the identity safe service provider. In step 604, the access controller 612 decodes the QR code, determines the user from the scope information, and requests that the user enter his or her biometric data (e.g., facial image, voiceprint or fingerprint) into his or her smartphone. In step 605, the user enters his or her biometric data into the smartphone and consents to the request for the identity data. After the identity safe service provider has authenticated the user by the entered biometric data, in step 606, it requests that the signed, encrypted identity data be retrieved from the public ledger 406b. In step 607, the DiD is sent to a smart contract 405a via API gateway 404. In step 608, smart contract 405a sends the DiD to the quasi-permission ledger 406a. In step 609, the quasi-permission ledger 406a sends the signed, encrypted user identity (“user information”) to a different smart contract 405b. In step 610, the signed, encrypted user identity is sent back to the service provider for decryption by the service provider. In addition, in step 611, the transaction is recorded in the public ledger 406b. This recording process is asynchronous, so one does not have to wait for confirmation of the transaction.

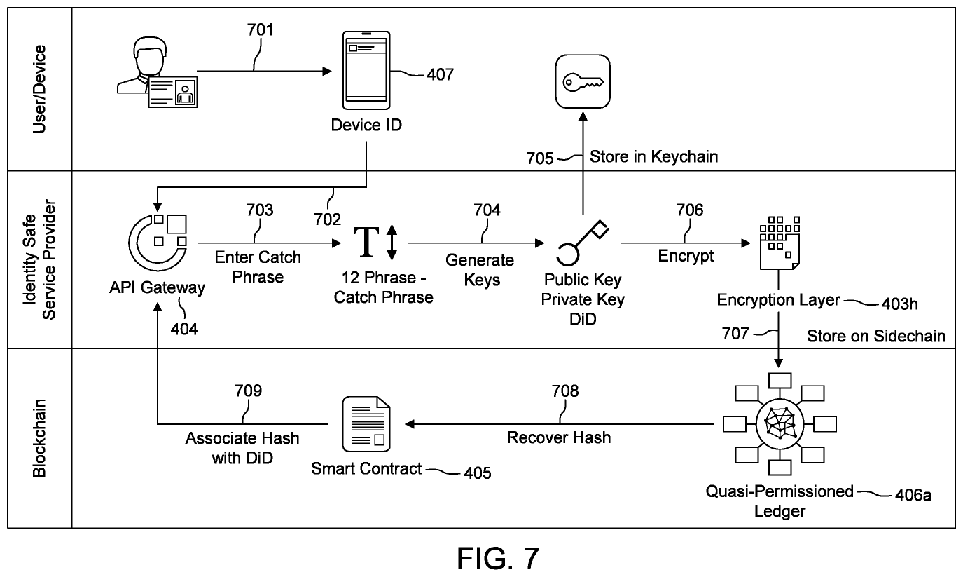

FIG. 7 depicts the operational flow of an exemplary recovery process in accordance with the present invention. This recovery process is used, for example, if user uses a new smartphone than he or she originally used to create the identity safe. In step 701, the user downloads the identity safe app 407 on the smartphone. In step 702, the smartphone's device id is passed through the API gateway 404 to the identity safe service provider. In step 703, the user goes to the recovery section of the identity safe app and enters the previously generated 12—word mnemonic catch phrase (see step 503). That catch phrase is used, in step 704, to regenerate the ECDSA public and private keys and DiD. In step 705, the private key is restored in the secure keychain of the user's smartphone. In step 706, the DiD is encrypted using the user's ECDSA private key and signed with the public key by the encryption layer 403h, and in step 707, the encrypted hash blob of the DiD is stored on the quasi-permissioned ledger. In step 708, the quasi-permissioned ledger generates a recovery hash. In step 709, smart contract 405 will fetch that hash and associate it with the DiD and send the DiD to the identity safe service provider via the API gateway 404, which in turn will restore the DiD back onto the user's new smartphone.

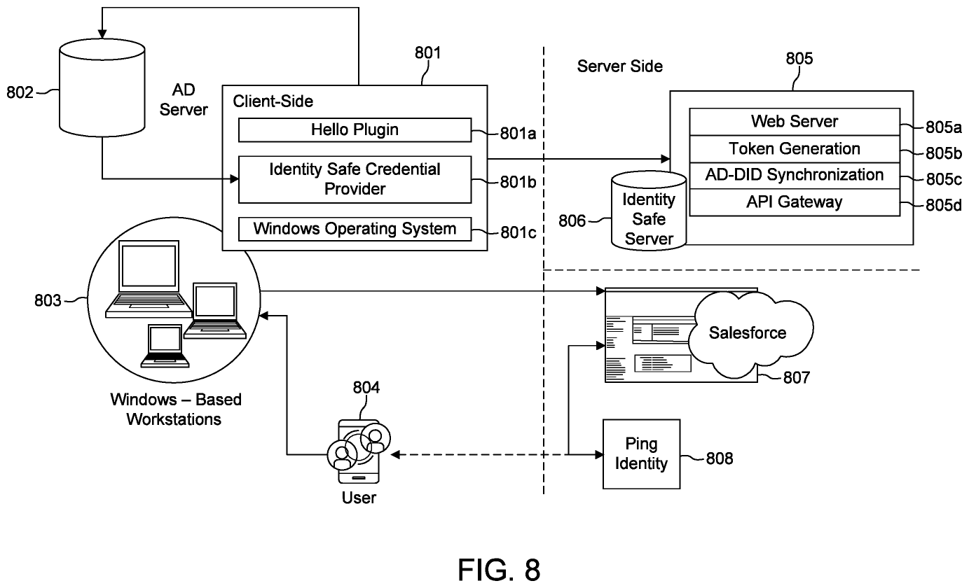

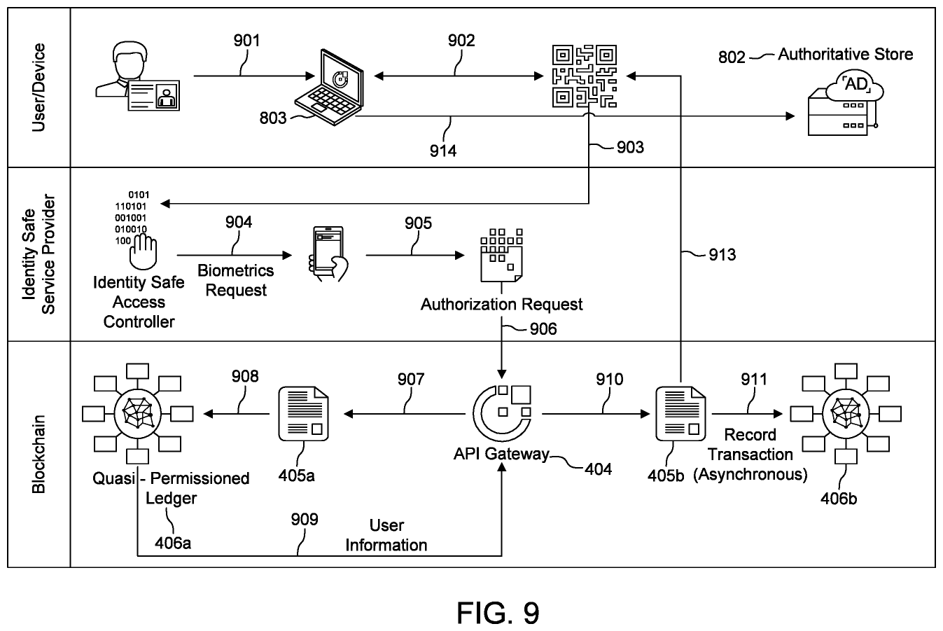

FIGS. 8 and 9 respectively depict the components and operational flow of an exemplary Windows workstation authentication process in accordance with the present invention. In FIG. 8, the client side 801 is comprised of Windows-based computing devices 803 which include a “Hello” plugin 801a located in the identity safe program files, an identity safe credential provider 801b located in the Windows operating system files, and the Windows operating system 801c. The client side computers interact with the Active Directory (AD) database 802. A user smartphone 804 (on which the identity safe app 407 has been installed) is communicatively connected to one or more of the Window-based workstation computers 803. The server side 805 includes the identity safe server 806, which is comprised of a Web server 805a, a token generator 805b, an AD-DiD synchronizer 805c, and API gateway 805d. The components of the client side 801 are communicatively connected to the components of the server side 805. Once the Windows-based Authentication request has been completed using the identity safe (see FIG. 9), a request is sent to the Single Sign On Provider (SSO) such as Ping Identity 808. The SSO allows the user to access enterprise applications such Salesforce Customer Relationship Manager (CRM) platform 807 over the Internet.

In step 901 of FIG. 9, the user makes a login request to one of the computer devices 803 by scanning the QR code displayed on the Windows workstation. The login request includes scope information, i.e., personal information about the user, such as the user's first or last name, date of birth or address. In step 902, the computing device 803 creates and displays a QR code which is encoded with the scope, the session id and the service provider's ECDSA public key, and requests the identity data it needs for authenticating the user. In step 903, the QR code is sent by the computing device 803 (i.e., workstation) to the identity data service provider's access controller. In step 904, the access controller decodes the QR code, determines the user from the scope information, and requests that the user enter his or her biometric data (e.g., facial image, voiceprint or fingerprint) into his or her smartphone. In step 905, the user enters his or her biometric data on the smartphone and consents to the request for the identity data. After the identity safe service provider has authenticated the user by the entered biometric data, in step 906, it requests that the signed, encrypted identity data be retrieved from the public ledger 406b. In step 907, the DiD is sent to a smart contract 405a via API gateway 404. In step 908, smart contract 405a sends the DiD to the quasi-permission ledger 406a. In step 909, the quasi-permission ledger 406a sends the signed, encrypted user identity (“user information”) to API gateway 404. In step 910, the signed, encrypted user identity is forwarded to a different smart contract 405b. In step 911, the transaction is recorded on the public ledger 406b. In step 913, the signed, encrypted user identity is sent back to the computing device 803 for decryption by the computing device 803. There is an identity safe agent running on every computing device 803. The identity safe server 806 captures the DiD and in step 914, associates the username from the authoritative store (such as Active Directory AD 802) to the DiD. The authoritative store (AD) has the association of the username along with the DiD. The factors of authentication are to be decided by the organization, and the authorization is to be done by the AD.

As discussed in the following paragraphs, the present invention meets the following standards: (1) NIST 800-63-3, as it complies with IAL 3 and AAL 3 requirements by providing multi-factor authentication and CSP requested biometric mechanism; (2) PAN Canadian Framework, for the same reason; and (3) CATS2 Specifications, as it complies with Triple Bind—anonymity policies for identity.

IAL 1: A CSP that supports only IAL1 shall not validate and verify attributes. The CSP may request zero or more self-asserted attributes from the applicant to support their service offering. An IAL2 or IAL3 CSP should support RP's that only require IAL1, if the user consents. In the present invention, when a user initially registers with the identity safe service provider, the name identifier is based on the name registered on the device. It could be a “mickey mouse” account. The identity safe does not validate and verify any of the attributes (name), and CSP's can request 0 or more attributes from the identity safe (name & DiD). All requested attributes from any CSP would require the user to consent to it using biometrics.

IAL 2: One piece of superior or strong evidence if the evidence's issuing source, during its identity proofing event, confirmed the claimed identity by collecting two or more forms of superior or strong evidence and the CSP validates the evidence directly with the issuing source; or two pieces of strong evidence; or one piece of strong evidence plus two pieces of fair evidence. In the present invention, the identity safe service provider collects from a user two pieces of strong evidence, for example, a driver's license and a passport. Both these documents are verified in real-time directly with the issuing source (via an identity hub) to be valid and not reported lost or stolen. Additionally the identity safe service provider validates that the data collected between the two pieces of identity documents are an exact match including the photographs.

IAL 3: The CSP shall confirm address of record. The CSP should confirm address of record through validation of the address contained on any supplied, valid piece of identity evidence. The CSP may confirm address of record by validating information supplied by the applicant, not contained on any supplied, valid piece of identity evidence. Self-asserted address data shall not be used for confirmation. A notification of proofing shall be sent to the confirmed address of record. The CSP may provide an enrollment code directly to the subscriber if binding to an authenticator will occur at a later time. The enrollment code shall be valid for a maximum of seven days. In the present invention, IAL3 can be achieved only if the user is IAL2. A real-time validation of the user's current address is done with direct integrations with backend address validation services to ensure that the user actually lives at the address as stated in the proof of identity document. The addresses themselves are not self-asserted, but rather extracted via the valid documents presented for IAL2.

AAL1: AAL1 has several requirements: Memorized Secret (Section 5.1.1); Look-Up Secret (Section 5.1.2); Out-of-Band Devices (Section 5.1.3); Single-Factor One-Time Password (OTP) Device (Section 5.1.4); Multi-Factor OTP Device (Section 5.1.5); Single-Factor Cryptographic Software (Section 5.1.6); Single-Factor Cryptographic Device (Section 5.1.7); Multi-Factor Cryptographic Software (Section 5.1.8); Multi-Factor Cryptographic Device (Section 5.1.9). In the present invention, the identity safe service provider does a complete out-of-band authentication using biometrics in adherence to Section 5.1.3, Section 5.1.4, Section 5.1.6, Section 5.1.7, Section 5.1.8, Section 5.1.9, as the distributed ID (DiD) itself is generated based on BIP 39 standard mnemonic phrase based identifiers linked to its own private and public keys.

AAL2: AAL2 provides high confidence that the claimant controls authenticator(s) bound to the subscriber's account. Proof of possession and control of two distinct authentication factors is required through secure authentication protocol(s). When a multi-factor authenticator is used, any of the following may be used: Multi-Factor OTP Device (Section 5.1.5); Multi-Factor Cryptographic Software (Section 5.1.8); or Multi-Factor Cryptographic Device (Section 5.1.9). In the present invention, the identity safe service provider uses multi-factor biometric authentication—Factor 1 is the biometrics used to unlock and use the app and Factor 2 is the CSP-requested biometric mechanism (face, voice, thumbprint or pin). As stated in the preceding paragraph, the identity safe service provider does a complete out-of-band authentication using biometrics.

AAL3: AAL3 provides very high confidence that the claimant controls authenticator(s) bound to the subscriber's account. Authentication at AAL3 is based on proof of possession of a key through a cryptographic protocol. In the present invention, as explained above, the identity safe service provider uses multi-factor biometric authentication, and does a complete out-of-band authentication using biometrics.

FAL1: FAL1 allows for a subscriber to enable the RP to receive a bearer assertion. The assertion is signed by the IdP using approved cryptography. In the present invention, the identity safe service provider encrypts all data transmitted using the public key of the third party service provider thus ensuring that only the intended third party service provider could decrypt the assertion. This encrypted data is signed by the identity safe service provider to enable third party service providers to verify the authenticity of the sender of the assertion.

FAL2: FAL2 adds the requirement that the assertion be encrypted using approved cryptography such that the RP is the only party that can decrypt it. In the present invention, the identity safe service provider meets this requirement by encrypting all data using ECDSA.

FAL3: FAL3 requires the subscriber to present proof of possession of a cryptographic key referenced in the assertion in addition to the assertion artifact itself. The assertion is signed by the IdP and encrypted to the RP using approved cryptography. In the present invention, the identity safe service provider ensures that only the user in possession of the identity credentials is able to decrypt the identity data and share elements of identity data or attributes as requested by the third party service provider.

In addition to the above, the FAL (for additional security & compliance) is dynamically calculated and is typically a lower of the 2 assurance levels for IAL and AAL (as indicated in the following table):

IAL1 + AAL1 = FAL1
IAL1 + AAL2 = FAL1
IAL1 + AAL3 = FAL1
IAL2 + AAL1 = FAL1
IAL2 + AAL2 = FAL2
IAL2 + AAL3 = FAL2
IAL3 + AAL1 = FAL1
IAL3 + AAL2 = FAL2
IAL3 + AAL3 = FAL3

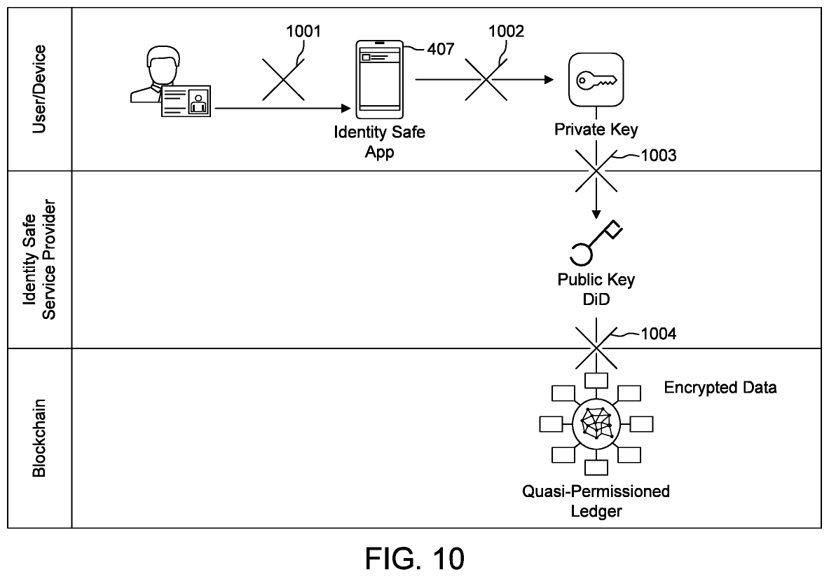

The identity safe of the present invention also permits a user's data to be completely forgotten, thus complying with that aspect of the General Data Protection Regulation (GDPR). FIG. 10 depicts the flow for a user to be disassociated with his or her identity safe. The user deletes the identity safe app from his or her smartphone in step 1001. This will automatically destroy the user private key stored in the smartphone (step 1002). Once the private key is destroyed, the public key and DiD are rendered useless (step 1003) and all the encrypted hashed user information that resides on the blockchain is no longer decryptable by any user or device (step 1004).

It should be understood that the embodiments and described use cases herein are only by way of example. Many new use cases can be encompassed and facilitated by the functionality described herein. Additionally, the operations described and shown herein may be executed with many kinds of computers. For example, the computers may include user devices, such as smartphones, mobile phones, tablets, desktop, laptop and notepad computers, hand-held devices, microprocessor systems, microprocessor-based or programmable consumer electronics, minicomputers, mainframe computers and the like.

The invention can also be practiced in distributed computing environments where tasks are performed by remote processing devices that are linked through a wire-based or wireless network. Server operations may also be performed and communicated between client computers, to facilitate transactions with the block chain ledger, server storage, and the like. These computers can communicate over networks, such as the Internet, but also local and wide area networks. The networks enable individual devices to transact with each other, such as by way of sending, receiving, and processing information. Information that is exchanged between computers can include different types of encrypted/hashed data and corresponding codes, QR codes, messages, alerts, notifications, and other types of data.

The messaging and communication functions described above enable the user devices containing the identity safe app, the identity safe service provider computers, third party service provider computers, the blockchain network, and other computing devices to send and receive user identity data for authentication and other purposes. For example, a user who desired to have his or her identity information verified and securely stored can use an identity safe app installed on their smartphones or other mobile devices to capture that information, as described above. Once the user's identity data has been validated, encrypted and securely stored on the blockchain ledger, it can be used for subsequent third party authentication. The third party may likewise use an app for to read and communicate the user identity data and other exchanged information, or code plug-ins can be inserted into a third party's commercial website.

In their entirety, the present inventions encompass (1) the above-described operations, methods and processes; (2) the components, devices and systems used for carrying out those operations, methods and processes; and (3) computer readable code on a computer readable medium that, when executed by a computer, performs those operations, methods and processes. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network-coupled computer system so that the computer readable code is stored and executed in a distributed fashion.

Modifications and variations are possible without departing from the scope of the invention defined in the claims. The various embodiments described herein may each correspond to an invention, or they may be combined to define further inventions. When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements. In view of the above, it will be seen that the several objects of the invention are achieved and other advantageous results attained. As various changes could be made in the above systems without departing from the scope of the invention, it is intended that all matter contained in the above description and shown in the accompanying drawings shall be interpreted as illustrative and not in a limiting sense.

What is claimed is:

1. A method for creating an identity safe in which identity data of a user is securely stored, comprising the steps of:
an identity safe service provider receiving from a device of the user two or more forms of user identity data;
verifying the user identity data;
generating a public key and a private key associated with the user, the private key being sent to and retained by the user's device;
encrypting and signing the user identity data with the public/private key pair; and
adding the encrypted and signed user identity data to a new block of a blockchain ledger, the new block being cryptographically linked to a prior block of the blockchain ledger.

2. A method according to claim 1, wherein identity safe service provider receives the two or more forms of user identity data from a software app on the user device, the software app being communicatively connected to the identity safe service provider.

3. A method according to claim 2, further comprising the steps of the identity safe service provider receiving the user's biometric data from the user's device, and authenticating the user based on the user's biometric data to permit the user to log into the identity safe service provider.

4. A method for authenticating a user logging into an online service provider, comprising the steps of:
the online service provider sending an authorization request for user identity data stored in an identity safe on a blockchain ledger;
the online service provider receiving user identity data, retrieved from the identity safe on the blockchain ledger, that has been encrypted and signed with a private/public key pair of the user, whereby the private key is securely maintained by the user; and
the online service provider verifying the signature and decrypting the user identity data with the user's private/public key pair, thereby permitting the online service provider to authenticate the user.

5. A method according to claim 4, wherein the online service provider sends the authorization request to an identity safe service provider, which routes the authorization request to the user's device.

6. A method according to claim 5, further comprising the steps of the identity safe service provider receiving the user's biometric data from the user's device in response to the authorization request and authenticating the user based on the user's biometric data to permit the user to log into the identity safe service provider.

7. A method according to claim 6, comprising the step of the identity safe service provider receiving from the user device the user's consent to provide the requested user identity data.

8. A method for paying an online service provider, comprising the steps of:
the online service provider sending an authorization request for user identity and payment data stored in an identity safe on a blockchain ledger;
the online service provider receiving user identity and payment data, retrieved from the identity safe on the blockchain ledger, that has been encrypted and signed with a private/public key pair of the user, whereby the private key is maintained by the user;
the online service provider verifying the signature and decrypting the user identity and payment data with the user's private/public key pair to authenticate the user and form of payment; and
the online service provider completing the payment.

9. A method according to claim 8, wherein the online service provider sends the authorization request to an identity safe service provider, which routes the authorization request to the user's device.

10. A method according to claim 9, further comprising the steps of the identity safe service provider receiving the user's biometric data from the user's device in response to the authorization request and authenticating the user based on the user's biometric data to permit the user to log into the identity safe service provider.

11. A method according to claim 10, comprising the step of the identity safe service provider receiving from the user device the user's consent to provide the requested user identity and payment data.

12. A method for authenticating a user logging into an online service provider, comprising the steps of:
an identity safe service provider receiving from the online service provider an authorization request for user identity data stored in an identity safe on a blockchain ledger;
the identity safe service provider retrieving from the identity safe on the blockchain ledger user identity data that has been encrypted and signed with a private/public key pair of the user, whereby the private key is maintained by the user; and
the identity safe service provider sending the signed, encrypted user identity data to the online service provider, the signature to be verified and the user identity data to be decrypted with the user's private/public key pair to permit the online service provider to authenticate the user.

13. A method according to claim 12, wherein the identity safe service provider routes the authorization request to the user's device.

14. A method according to claim 13, further comprising the steps of the identity safe service provider receiving the user's biometric data from the user's device in response to the authorization request and authenticating the user based on the user's biometric data to permit the user to log into the identity safe service provider.

15. A method according to claim 14, comprising the step of the identity safe service provider receiving from the user device the user's consent to provide the requested user identity data.

16. A method for paying an online service provider, comprising the steps of:
an identity safe service provider receiving from the online service provider an authorization request for user identity and payment data stored in an identity safe on a blockchain ledger;
the identity safe service provider retrieving from the identity safe on the blockchain ledger user identity and payment data that has been encrypted and signed with a private/public key pair of the user, whereby the private key is maintained by the user; and
the identity safe service provider sending the signed, encrypted user identity and payment data to the online service provider, the signature to be verified and the user identity and payment data to be decrypted with the user's private/public key pair, to permit the online service provider to authenticate the user and form of payment and complete the payment.

17. A method according to claim 16, wherein the identity safe service provider routes the authorization request to the user's device.

18. A method according to claim 17, further comprising the steps of the identity safe service provider receiving the user's biometric data from the user's device in response to the authorization request and authenticating the user based on the user's biometric data to permit the user to log into the identity safe service provider.

19. A method according to claim 18, comprising the step of the identity safe service provider receiving from the user device the user's consent to provide the requested user identity and payment data.

20. A system comprising:
an identity safe service provider computer that implements an identity safe, the identity safe securely storing user identity data, the identity safe service provider computer communicatively connected to and interacting with (1) one or more third party apps for authenticated login and payment purposes and (2) an identity safe app that provides the user identity data; and
an API gateway to handle API service calls, the API gateway communicatively connected to and interacting with one or more smart contracts used to exchange the user identity data between the identity safe service provider computer and a blockchain ledger.
